(19) United States
(12) Patent Application Publication
(10) Pub. No.: US 2025/0356585 A1
(43) Pub. Date: Nov. 20, 2025

(54) MAP RENDERING METHOD, APPARATUS AND DEVICE, AND PROGRAM PRODUCT

(71) Applicant: Beijing Autonavi YunMap Technology Co., Ltd., Beijing (CN)

(72) Inventors: Zhishan XING, Beijing (CN); Yongfeng ZHU, Beijing (CN)

(21) Appl. No.: 19/291,696

(22) Filed: Aug. 6, 2025

Related U.S. Application Data
(63) Continuation of application No. PCT/CN2023/138503, filed on Dec. 13, 2023.

(30) Foreign Application Priority Data
Feb. 17, 2023 (CN) 202310171964.1

(51) Int. Cl. G06T 17/05; G06T 1/20; G06V 10/56

(52) U.S. Cl. CPC G06T 17/05; G06T 1/20; G06V 10/56

(57) ABSTRACT

A map rendering method comprises: obtaining map data, wherein the map data comprises more than one set of model data, and the model data comprises attribute data representing attributes for rendering map elements; organizing the attribute data corresponding to a same attribute across the more than one set of model data into a data group for storage, to obtain organized attribute data, and generating index data; generating a data filling instruction to transmit the organized attribute data and the corresponding index data to a graphics processing unit (GPU); and generating a map rendering instruction to trigger the GPU to render the map elements corresponding to the map data based on the organized attribute data and the corresponding index data.

### CROSS-REFERENCE TO RELATED APPLICATION

This application is a Continuation application of International Patent Application No. PCT/CN2023/138503, filed on Dec. 13, 2023, which is based on and claims priority to and benefits of Chinese patent application No. 202310171964.1, filed with the China National Intellectual Property Administration on Feb. 17, 2023, titled “Map Rendering Method, Apparatus and Device, and Program Product.” The above-referenced applications are incorporated herein by reference in their entirety.

### TECHNICAL FIELD

The present application relates to the field of map rendering technologies, and more particularly, to a map rendering method, apparatus, device, and program product.

### BACKGROUND

With the development of Internet technologies, electronic maps have been applied in an increasing number of scenarios. A visualized electronic map is dynamically rendered by a map rendering engine based on a location (such as a user's current location or the area being viewed) and map data.

The inventors of the present application have discovered that, during the map rendering process, the Central Processing Unit (CPU) needs to submit rendering instructions (draw calls) to the Graphics Processing Unit (GPU). However, since the uniform variables in rendering instructions can only transmit a single color, when an electronic map region requires rendering with a plurality of color effects, the CPU must generate a separate rendering instruction for each color. The greater the number of colors to be rendered, the heavier the load on the CPU, which leads to degraded rendering performance of the map rendering engine.

Therefore, there is an urgent need to provide a high-efficiency method for rendering electronic maps.

### SUMMARY

The present application provides a map rendering method, apparatus, device, and program product. By integrating a plurality of sets of model data, the invention enables the rendering of a plurality of models through a single rendering instruction, thereby improving map rendering efficiency.

In a first aspect, the present application provides a map rendering method, including:
obtaining map data, wherein the map data includes more than one set of model data, and the model data includes attribute data representing attributes for rendering map elements; organizing the attribute data corresponding to a same attribute across the more than one set of model data into a data group for storage, to obtain organized attribute data, and generating index data, wherein the index data is configured to indicate storage locations of the attribute data corresponding to the attributes of the map elements; generating a data filling instruction to transmit the organized attribute data and the corresponding index data to a graphics processing unit (GPU); and generating a map rendering instruction to trigger the GPU to render the map elements corresponding to the map data based on the organized attribute data and the corresponding index data.

In a second aspect, the present application provides another map rendering method, including:
in response to a map rendering instruction, reading corresponding organized attribute data and associated index data, wherein the corresponding organized attribute data is obtained by organizing attribute data corresponding to a same attribute across more than one set of model data into a data group, the model data including attribute data representing attributes for rendering map elements, and the index data being configured to indicate storage locations of the attribute data corresponding to the attribute of the map element within the organized attribute data; and
rendering more than one map element corresponding to the map rendering instruction based on the organized attribute data and the associated index data.

In a third aspect, the present application provides a map rendering apparatus, including:
a map data acquisition module configured to obtain map data, wherein the map data includes more than one set of model data, and the model data includes attribute data representing attributes for rendering map elements;
a data integration module configured to organize attribute data corresponding to a same attribute across the more than one set of model data into a data group for storage to obtain organized attribute data, and to generate index data, wherein the index data is configured to indicate storage locations of the attribute data corresponding to the attributes of the map elements;
a data filling instruction generation module configured to generate data filling instructions to transmit the organized attribute data and corresponding index data to a graphics processing unit (GPU); and
a rendering instruction generation module configured to generate a map rendering instruction to trigger the GPU to render the map elements corresponding to the map data based on the organized attribute data and the corresponding index data.

In a fourth aspect, the present application provides a map rendering device, including:
a processor and a memory communicatively coupled to the processor; the memory stores computer-executable instructions; the processor executes the computer-executable instructions stored in the memory to implement the map rendering method provided in any aspect of the present application.

In a fifth aspect, the present application provides a computer-readable storage medium, wherein the computer-readable storage medium stores computer-executable instructions, which, when executed by a processor, are configured to implement the map rendering method provided in any aspect of the present application.

In a sixth aspect, the present application provides a computer program product, including a computer program, which, when executed by a processor, is configured to implement the map rendering method provided in any aspect of the present application.

The map rendering method, apparatus, device, and program product provided in the present application address the rendering of a plurality of models within a map by obtaining the corresponding map tile data, which includes more than one set of model data. The model data includes attribute data for rendering map element attributes, such as color, vertex coordinates, and other properties. In order to reduce the number of rendering instructions and consequently reduce the number of rendering batches, the method first integrates a plurality of sets of model data in the map data based on their attributes. Specifically, attribute data of the same attribute is organized into a data group to obtain organized attribute data, and index data is generated to facilitate data batching. A data filling instruction is used to transmit the previously generated organized attribute data and index data to the GPU. Then, a single rendering instruction is generated to instruct the GPU to render a plurality of models corresponding to the map data in a single batch. This enables rendering of a plurality of models corresponding to the map data through a single rendering batch, significantly improving batching efficiency. By associating each set of map data with a single rendering batch, the number of rendering instructions is greatly reduced, thereby lowering the CPU performance requirements for map rendering. This improves the workload balance between the CPU and GPU, reduces the GPU's idle time, and enhances the overall efficiency of map rendering.

### BRIEF DESCRIPTION OF THE DRAWINGS

In order to more clearly illustrate the technical solutions in the embodiments or related technologies of the present application, the drawings required for the description of exemplary embodiments or related technologies are briefly introduced below. It is obvious that the drawings described below are only some exemplary embodiments of the present application. For those skilled in the art, other drawings can also be obtained based on these drawings without any creative effort.

FIG. 1 is a schematic diagram of a map rendering process provided in an embodiment of the present application.

FIG. 2 is a flowchart illustrating a map rendering method provided in an embodiment of the present application.

FIG. 3 is a flowchart illustrating another map rendering method provided in an embodiment of the present application.

FIG. 4 is a schematic diagram of a model data integration process provided in an embodiment of the present application.

FIG. 5 is a flowchart illustrating yet another map rendering method provided in an embodiment of the present application.

FIG. 6 is a schematic structural diagram of a map rendering apparatus provided in an embodiment of the present application.

FIG. 7 is a schematic structural diagram of a map rendering device provided in an embodiment of the present application.

### DETAIL DESCRIPTION OF THE EMBODIMENTS

The exemplary embodiments of the present application are described in detail below with reference to the accompanying drawings, so as to enable those skilled in the art to easily implement them. For the sake of clarity, parts irrelevant to the description of the exemplary embodiments are omitted in the drawings.

Furthermore, it should be understood by those of ordinary skill in the art that the drawings provided herein are for illustrative purposes only and are not necessarily drawn to scale.

Unless otherwise explicitly required by the context, the terms “comprise,” “include,” and similar expressions in the specification should be interpreted as non-exclusive and non-exhaustive, i.e., as meaning “including but not limited to.”

In the description of the present application, it should be understood that the terms “first,” “second,” and the like are used solely for descriptive purposes and should not be construed as indicating or implying relative importance. In addition, unless otherwise specified, the term “plurality” means two or more.

Unless otherwise expressly specified and defined, the terms such as “mounted,” “connected,” “coupled,” and “fixed” should be interpreted broadly. For example, the connection may be a fixed connection or a detachable connection, or may be integrally formed; it may be a mechanical connection or an electrical connection; it may be a direct connection or an indirect connection through an intermediate medium; and it may refer to communication within or interaction between two components, unless explicitly defined otherwise. Those skilled in the art can interpret the specific meanings of the above terms in the present application based on the particular context.

It should also be noted that, where there is no conflict, the embodiments in the present application and the features in the embodiments may be combined with one another.

The present application is proposed at least in part to address the problems identified by the inventors in the prior art.

Firstly, the terms related to the present application are defined as follows:
map data: an electronic map (referred to as “map” hereinafter) is typically divided into plurality of tiles for management. Each tile corresponds to a geographic region in the real world. The map data includes model data of various map features within the corresponding geographic region, such as model data for buildings, rivers, green spaces, and the like;
uniform buffer object (UBO): a buffer object used to store uniform variables. A uniform is a way of transmitting data from a CPU-side application to a GPU-side shader. Uniforms are global variables, meaning that each uniform variable is unique within a shader program object. This restricts each access to a uniform variable within any shader to yield only a single value (e.g., a single color);
data filling instruction: an instruction used to fill data into a designated area, allowing for the batch filling of data.

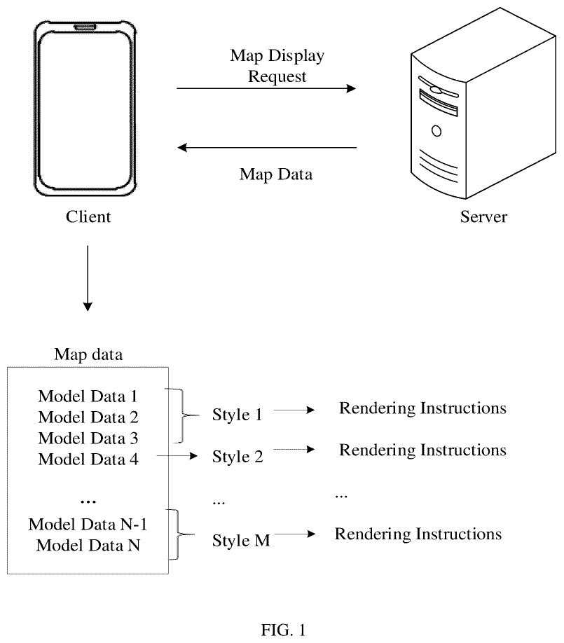

FIG. 1 is a schematic diagram of a map rendering process provided in an embodiment of the present application. As shown in FIG. 1, a user initiates a map display (rendering) request through a client. The server responds to the map display request and delivers the corresponding map data—based on the user's current location or a location specified by the user—to the client. The map data includes several map tiles calculated based on the specified or current location, enabling the client to perform map rendering. Taking the model data of a building as an example, a single building can correspond to a set of model data, which includes various data required to render specific attributes of the building, such as vertex data for rendering vertex attributes, color data for rendering color attributes, and texture data for rendering texture attributes.

Since the rendering speed of the GPU is generally higher than the speed at which the CPU completes the preparation of draw call (rendering instructions), an increased number of draw calls results in a greater CPU workload, placing higher demands on CPU performance. This imbalance leads to longer GPU idle time, causing resource waste and longer rendering times, ultimately resulting in lower rendering performance.

In order to reduce the number of draw calls, batch processing—i.e., batch rendering—can be employed. During batch processing, model data within the same tile is typically grouped based on style; specifically, model data with the same style is batched together. Styles may refer to the same color, the same material, or the same texture. When the map data contains model data of a plurality of styles—as illustrated in FIG. 1, where N (a positive integer greater than 5) model data entries correspond to M (a positive integer greater than 2) different styles—batch processing still results in M rendering instructions being generated. The resulting batching efficiency remains relatively low, thus offering only limited improvement to overall map rendering performance.

In order to further improve the batching degree, reduce the demands on CPU performance, and enhance map rendering efficiency, the present application provides a map rendering method that integrates attribute data from a plurality of model data entries in the map data based on attributes. By organizing these attribute data into organized attribute data and corresponding index data, and transmitting both to the GPU, a single rendering instruction is then generated to instruct the GPU to perform rendering based on the received data. This solution effectively achieves the merging of a plurality of models within the map data into a single model, without the need to consider whether their styles (e.g., color, texture) are the same. As a result, each map data set corresponds to only one rendering instruction, which significantly increases the level of batching and greatly improves the efficiency of map rendering.

The following provides a detailed description of embodiments of the present application, explaining how the technical solutions address the aforementioned technical problems. The following embodiments may be combined with one another, and for identical or similar concepts or processes, some explanations may be omitted for brevity. The embodiments of the present application will be described below with reference to the accompanying drawings.

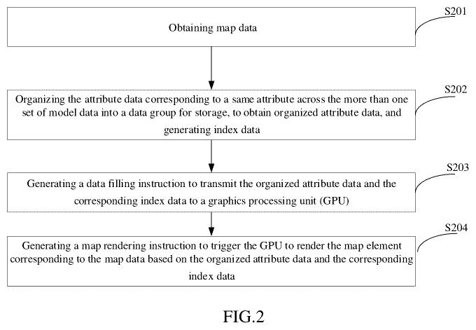

FIG. 2 is a flowchart illustrating a map rendering method provided in an embodiment of the present application. This map rendering method may be executed by an electronic device with appropriate data processing capabilities, such as a map rendering device or the CPU of a map rendering device. The map rendering device may be a client device, such as a mobile phone, tablet computer, smart wearable device, or similar.

As shown in FIG. 2, the map rendering method includes the following steps:
S201: obtaining map data.

The map data includes model data of one or more map elements. The model data includes attribute data used for rendering the map elements. These map elements may be features such as buildings, rivers, etc., that are to be rendered.

The map data is organized based on map tiles calculated from the user's current location or a location specified by the user. That is, the map data obtained in Step S201 is structured by tiles.

The map data includes model data for a plurality of geographic features within the corresponding geographic area, such as model data for buildings, rivers, lawns, and other elements. When the geographic features in a given area are relatively uniform, the map data may include model data for only a single type of feature—for example, solely Level of Development (LOD) building models. A single building may be rendered using one or a plurality of colors.

When a user launches a client-side application equipped with electronic map rendering capabilities, the client is triggered to send a request to a server for map data corresponding to an area surrounding the user's current location (i.e., the location of the client), or alternatively, the area surrounding a location on the map after the user has performed a drag operation. Upon receiving the request, the server determines the set of map tiles to be included in the map data based on one or more rendering parameters uploaded by the client. The rendering parameters may include, but are not limited to: the client's current location or the center position of the map after the drag operation, a map scale level, and a map display mode. The server then transmits the determined map data to the client, which utilizes the received map data for rendering purposes. When the map data includes building information, the building model data to be rendered may be classified based on building types, such as residential, commercial, or industrial buildings, thereby enabling differentiated rendering based on the respective building categories.
S202: organizing the attribute data corresponding to a same attribute across the more than one set of model data into a data group for storage, to obtain organized attribute data, and generating index data.

The index data is configured to indicate the storage location of attribute data corresponding to attributes of the map elements. For example, in the case where the attribute is a vertex, the corresponding attribute data comprises vertex data, which may represent the positions of the respective vertices included in the associated model. As another example, where the attribute is color, the corresponding attribute data comprises color data, which may represent color values, such as red, green, blue, or other color values.

The organized attribute data may include, for each attribute, a corresponding attribute array, wherein the attribute array comprises attribute data corresponding to that attribute from one or more pieces of model data. The index data may also be represented in the form of an array, referred to as an index array.

Specifically, a plurality of pieces of model data within the map data may be merged into a single piece of model data based on their attributes. The merged model data comprises, for each attribute, a corresponding attribute array, as well as an index array. Each attribute array contains attribute data corresponding to a particular attribute, aggregated from the respective attribute data of a plurality of pieces of model data in the map data. Each element in the index array is configured to indicate the storage location of the attribute data corresponding to a specific attribute of a map element.
S203: generating a data filling instruction to transmit the organized attribute data and the corresponding index data to a graphics processing unit (GPU).

The data filling instruction is configured to instruct that the data obtained in Step S202, including the organized attribute data and the corresponding index data, be stored at a specified location, so that the GPU can read the required rendering data from the specified location.

Specifically, through the data filling instruction, attribute data (excluding color data) and the corresponding index data within the organized attribute data may be stored in the CPU cache, while the organized color data may be stored in a uniform buffer object.
S204: generating a map rendering instruction to trigger the GPU to render the map element corresponding to the map data based on the organized attribute data and the corresponding index data.

The map rendering instruction, also referred to as a draw call, is configured to trigger the GPU to perform map rendering.

Specifically, the CPU generates a map rendering instruction, and the GPU responds to the map rendering instruction by performing map rendering based on the received organized attribute data and the corresponding index data. The rendering process specifically involves rendering a plurality of map elements (a plurality of models) corresponding to the map data in a single batch, thereby generating a visualized map.

The map rendering method provided in the present application is specifically designed for the rendering of a plurality of models within a map. It involves obtaining the corresponding map tile data, wherein the map tile data includes one or more pieces of model data. The model data comprises attribute data representing the attributes of the corresponding map elements, such as color, vertex positions, and other attributes. To reduce the number of rendering instructions and thereby minimize the number of rendering batches, the method first integrates a plurality of pieces of model data within the map data based on their attributes. Specifically, it organizes attribute data of the same type into data group, thereby generating organized attribute data along with corresponding index data, achieving efficient data batching. The organized attribute data and index data are then transmitted to the GPU through data filling instructions. Subsequently, a single rendering instruction is generated to instruct the GPU to render a plurality of models corresponding to the map data in a single batch, thereby achieving batch rendering for a plurality of models within the map data. This approach significantly improves batching efficiency by reducing the number of rendering instructions required per map tile, thereby lowering the computational burden on the CPU, improving the balance of workload between the CPU and GPU, reducing GPU idle time, and ultimately enhancing overall map rendering efficiency.

Optionally, the attributes of the model data may include vertices and colors. The attribute data corresponding to the vertices is vertex data, and the attribute data corresponding to the colors is color data. The organized attribute data includes a color array and a vertex array, wherein the color array contains the color data from the respective model data within the map data, and the vertex array contains the vertex data from the respective model data within the map data.

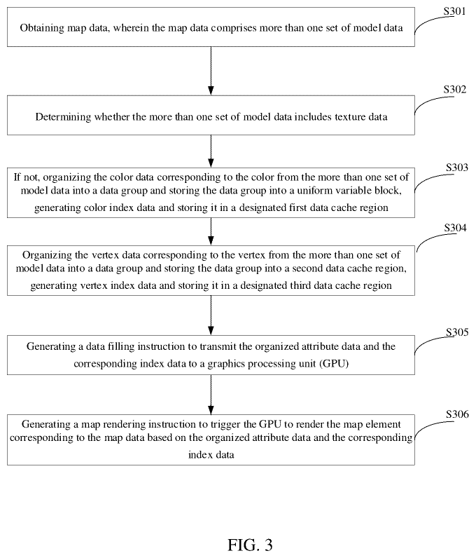

FIG. 3 is a schematic flowchart illustrating another map rendering method provided by an embodiment of the present application. This embodiment builds upon the method illustrated in FIG. 2, providing a further refinement of Step S202 and introducing additional steps prior to Step S202 to determine whether the model data includes texture data. As shown in FIG. 3, the map rendering method provided in this embodiment may include the following steps:
S301: obtaining map data, wherein the map data comprises more than one set of model data.

The model data is configured to describe at least two types of attributes corresponding to the respective model.
S302: determining whether the more than one set of model data includes texture data.

The determination can be made by checking whether the attributes corresponding to each piece of model data include the “texture” attribute. If the texture attribute is present, then the model data contains texture data.

Texture data is used to describe the texture of a model. When the model data includes texture data, the GPU typically requires a longer processing time to complete the rendering of the model. Therefore, for models that include texture data, batch rendering may be avoided. Instead, such models may be rendered individually, based on their respective model data. Specifically, for model data that includes texture data, the model data is transmitted to the GPU, along with a corresponding rendering instruction, to enable the GPU to render the texture-containing model based on the provided model data.

If the model data of any model within the map data includes texture data, the traditional rendering method may be used to render the plurality of models corresponding to the map data. Specifically, this involves transmitting each piece of model data to the GPU in a certain order, and after transmitting each piece of model data, transmitting a corresponding rendering instruction, thereby rendering each model corresponding to the map data in sequence.

In some embodiments, if none of the model data includes texture data, S202 of the above-described embodiment may be executed to perform data integration, thereby achieving batch rendering.

In other embodiments, rendering may also be performed according to the scheme provided in S303 to S306.

Furthermore, the model data within the map data may be grouped based on whether the model data includes texture data. For a group of models whose model data includes texture data, a batch-based rendering approach may be adopted, wherein each model's data corresponds to a separate rendering instruction, and the models are rendered one by one. For a group of models whose model data does not include texture data, a merged batch rendering approach similar to that described in S202 to S204 may be used. Specifically, the attribute data of the same attribute (e.g., color data, vertex data, normal data, etc.) across the model data in the group is organized into a data group and stored, to obtain organized attribute data corresponding to each attribute, and index data is generated. A data filling instruction and a single map rendering instruction corresponding to the group of model data are then generated to trigger the GPU to render the entire group of models.
S303: if not, organizing the color data corresponding to the color from the more than one set of model data into a data group and storing the data group into a uniform buffer object, generating color index data and storing it in a designated first data cache region.
S304: organizing the vertex data corresponding to the vertex from the more than one set of model data into a data group and storing the data group into a second data cache region, generating vertex index data and storing it in a designated third data cache region.

The color data is used to describe the color attributes of the model, and the vertex data is used to describe the vertex attributes of the model. The color index data is used to indicate the storage location of the color data for the map features within the uniform buffer object (UBO). The vertex index data is used to indicate the storage location of the vertex data corresponding to the vertices of the map features within the second data cache region. The first through third data cache region refer to different GPU cache regions.

If the model data in the map data does not include texture data, a data group corresponding to each attribute and the corresponding index data is generated based on the plurality of model data entries corresponding to the map data. In some embodiments, attributes include color and vertex data, as an example.

If the model data in the map data does not include texture data, the model data can be merged by attribute to obtain a data group corresponding to each attribute, namely the organized attribute data for each respective attribute.

Taking the vertex attribute as an example, the vertex data corresponding to each model in the map data can be merged into a single array in a predefined order. An empty array may first be initialized as the vertex array. Then, the model data within the map data is traversed in a certain order to extract the vertex data from each model, and the newly extracted vertex data is appended to the end of the vertex array. After appending the last vertex data, a complete vertex array is obtained-representing the organized vertex data for the vertex attribute.

By way of example, assume that map data Tile10 includes five models, denoted as models m101 to m105, and that the vertex data of models m101 to m105 are arrays d1 to d5, respectively. The vertex array corresponding to Tile10 would therefore be [d1, d2, d3, d4, d5].

Arrays corresponding to other attributes may be generated in a manner similar to that of the vertex array and will not be redundantly described here.

For building models, the shape is typically a cube, which includes 8 vertices. In some embodiments, other polyhedral shapes may be used to represent the building models, in which case the number of vertices may be 10, 12, or another suitable quantity.

In some embodiments, in order to reduce the number of elements in the color array and thereby lower resource usage, the colors corresponding to elements in the color array are mutually distinct.

Optionally, the model data in the map data may be merged by attribute to obtain a data group corresponding to each attribute. This includes:
extracting the color data and vertex data from each model data entry in the map data; merging the extracted vertex data to obtain the vertex array; and generating the color array based on the color data of each model, wherein the colors represented by each element in the color array are mutually distinct. The vertex array represents the data group corresponding to the vertex attribute, and the color array represents the data group corresponding to the color attribute.

Specifically, the extracted vertex data from each model can be merged into a vertex array. For the color data, before adding a new color to the color array, it is determined whether the color already exists in the color array. If not, the new color is appended to the end of the color array. This process is repeated until a complete color array is obtained.

Optionally, the color data corresponding to the color attribute in one or more model data entries is organized into a data group and stored in a uniform buffer object (UBO), including:
extracting the color data corresponding to the color attribute from the one or more model data entries; if there are duplicate values in the color data, organizing the non-duplicate color data and one instance of each duplicate color value into a data group and storing it in the uniform buffer object.

The duplicate values in the color data refer to color values that are identical across different models. For example, if both model A and model B correspond to the same color, such as gray, the color data for model A and model B would be considered duplicate values. In such cases, only one instance of the duplicate color needs to be retained.

By eliminating duplicate color data, the amount of color data stored in the uniform buffer object is reduced, thereby lowering storage costs.

When the models in the map data correspond to a plurality of colors, the uniform buffer object will store a plurality of color values. To enable batched rendering, color index data must be generated to determine the rendering color for each model via the color index. Specifically, the color index data can be generated based on the storage locations of the color data in the uniform buffer object and the association between each color data entry and its corresponding model. The color index data may be a color index array that includes a plurality of color indices, each indicating the storage location of the corresponding color data.

A color index array may be generated based on the association between each color data entry and its corresponding model, as well as the storage location of each color data entry.

By way of example, color data may be represented using 16 bytes, while color index data may be represented using 1 byte or another smaller byte size. This allows repeated use of the same color data via color indices, thereby reducing memory consumption.

In some embodiments, the model data may further include normal data (i.e., attribute data corresponding to the normal attribute). The normal data is used to indicate the position of the normal of the model. In this case, the normal data corresponding to the normals in one or more sets of model data is organized into a group for storage, such as being stored in a fourth data cache region.

In S305, generating a data filling instruction to transmit the organized attribute data and the corresponding index data to a graphics processing unit (GPU).

Optionally, the data filling instruction includes a first data filling instruction and at least one second data filling instruction. Generating the data filling instruction to transmit the organized attribute data and the corresponding index data to the GPU includes:
generating the first data filling instruction to transmit the vertex index data to the GPU; and generating the at least one second data filling instruction to transmit the organized color data, the color index data, and the organized vertex data to the GPU.

The second data filling instruction may comprise one, two, or three instructions.

The vertex index data is an Element Buffer Object (EBO), while the organized color data, color index data, and organized vertex data are Vertex Buffer Objects (VBOs). Due to the differences in object types, different Application Programming Interfaces (APIs) are invoked when transmitting data to the graphics card. Therefore, it is necessary to generate one data filling instruction, i.e., the first data filling instruction, for the vertex index data, and one or more additional data filling instructions, i.e., at least one second data filling instruction, for the organized color data, color index data, and organized vertex data.

By way of example, the number of second data filling instructions may be three, respectively used to transmit the organized color data, the color index data, and the organized vertex data to the GPU.

In S306, generating a map rendering instruction to trigger the GPU to render the map element corresponding to the map data based on the organized attribute data and the corresponding index data.

After receiving the map rendering instruction, the GPU performs map rendering based on the data corresponding to the rendering instruction. The GPU determines the storage locations of the vertices based on the vertex index data, reads the corresponding vertex data, and renders the shapes of the respective modules based on the vertex data. The shader reads the color of each module from the color data using the color index data and passes the color into the shader. The shader then performs rendering of the regions corresponding to the vertices based on the input color. In this manner, a plurality of models can be rendered using a single rendering instruction.

In some embodiments, before integrating a plurality of sets of model data, it is first determined whether the model data contains texture data. For map data whose model data includes texture data, batch rendering cannot be applied; instead, traditional multi-pass rendering is used to avoid excessive workload on the GPU during a single batch render, which could otherwise lead to severe power consumption on the client device. For map data whose model data does not include texture data, the attribute data corresponding to each attribute in the plurality of sets of model data is integrated to obtain organized attribute data for each attribute, which is then stored. This achieves the effect of consolidating a plurality of sets of model data into a single set of model data—essentially merging a plurality of models into a single model. The rendering data required is then transmitted to the GPU based on the data filling instructions, and the GPU is triggered to perform multi-model rendering via the map rendering instruction. In some embodiments, when rendering a plurality of models corresponding to map data, the CPU only needs to issue a single rendering instruction, which greatly reduces the number of rendering instructions. The GPU can determine the color of each model during rendering based on the color index data, thereby enabling a plurality of models (possibly in different colors) to be rendered using a single rendering instruction. This improves the degree of batching, enhances the efficiency of rendering instruction generation by the CPU, reduces GPU idle time, and improves overall rendering efficiency.

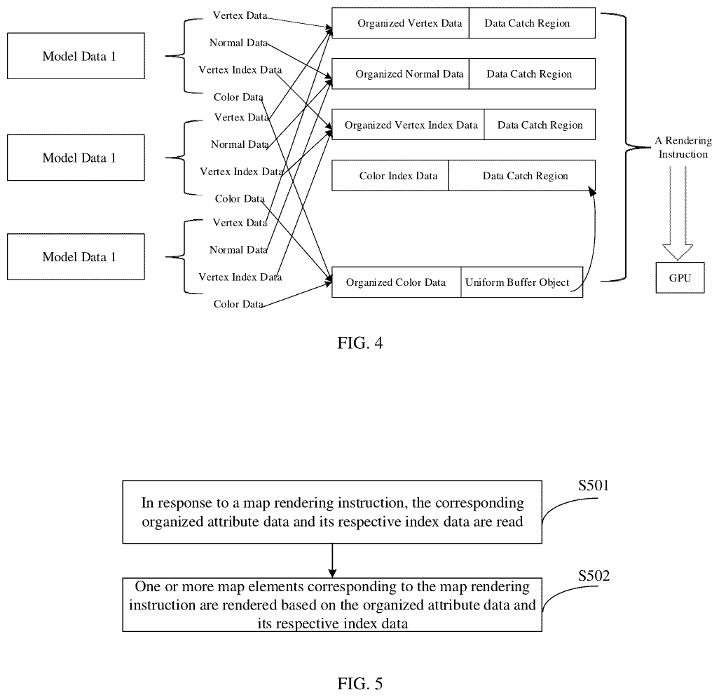

FIG. 4 is a schematic diagram illustrating the model data integration process provided in an embodiment of the present application. The data integration process corresponds to step S202 and is used to obtain the organized attribute data and generate index data. In FIG. 4, map data includes three sets of model data (model data 1 to model data 3), each of which includes vertex data, color data, normal data, and vertex index data. As shown in FIG. 4, the model data integration process mainly comprises:
a data integration stage, in which a plurality of sets of model data from the map data are integrated. Specifically, the vertex data from each model is aggregated and organized into a single data group and stored in a data cache region; the normal data from each model is aggregated and organized into a single data group and stored in a data cache region; the color data from each model is extracted, organized into a single data group, and stored in a uniform buffer object, where the color data stored in the uniform buffer object is non-redundant. Based on the storage locations of the color data in the uniform buffer object, color index data is generated and stored in a data cache region. The vertex index data from each model is also aggregated, organized into a single data group, and stored in a data cache region. In the rendering instruction issuing stage, through data filling instructions, the organized vertex data, organized normal data, organized color data, color index data, and organized vertex index data are transmitted to the GPU, and a single rendering instruction (map rendering instruction) is generated. The GPU, in response to this rendering instruction, completes the rendering of a plurality of models, including models with different colors.

FIG. 5 is a flowchart illustrating another map rendering method provided in an embodiment of the present application. The map rendering method in this embodiment is executed by the GPU of a map rendering device. As shown in FIG. 5, the map rendering method includes the following steps:
S501: in response to a map rendering instruction, reading corresponding organized attribute data and associated index data.

The corresponding organized attribute data is obtained by organizing the attribute data of the same attribute from one or more sets of model data into a single data group. The model data includes attribute data corresponding to attributes used for rendering map elements. The index data is used to indicate the storage locations of the attribute data, corresponding to the attributes of the map elements, within the organized attribute data.
S502: rendering more than one map element corresponding to the map rendering instruction based on the organized attribute data and the associated index data.

Optionally, the attributes of the model data include vertices and colors. The attribute data corresponding to the vertices is vertex data, and the attribute data corresponding to the colors is color data. The organized attribute data includes organized vertex data and organized color data. The organized vertex data is stored in a second data cache region, and the organized color data is stored in a uniform buffer object. The index data includes color index data and vertex index data. The color index data is stored in a designated first data cache region, and the vertex index data is stored in a designated third data cache region. Before reading the corresponding organized attribute data and its respective index data in response to the map rendering instruction, the method further includes:
in response to the first data filling instruction, obtaining the vertex index data from the third data cache region; and in response to at least one second data filling instruction, obtaining the organized color data from the uniform buffer object, the organized vertex data from the second data cache region, and the color index data from the first data cache region.

In some embodiments, a building model may correspond to a specific color. The color index in the color index data is used to indicate the color or the storage location of the color data corresponding to the first vertex (or another designated vertex) of the building model.

By setting the color index data, the shader is enabled to extract the corresponding colors in a predetermined order, allowing for the simultaneous batch rendering of a plurality of models with different colors.

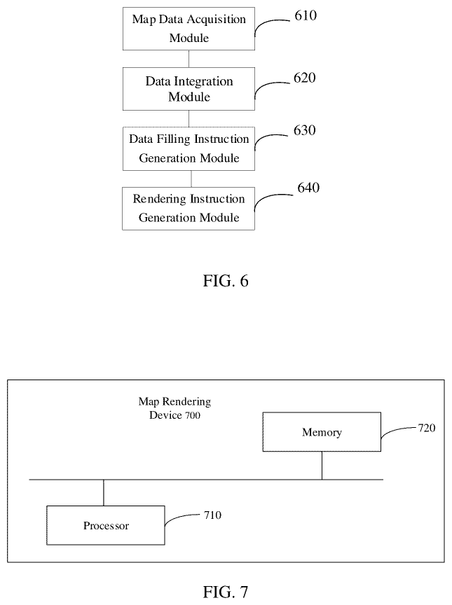

FIG. 6 is a schematic structural diagram of a map rendering apparatus provided in an embodiment of the present application. The map rendering apparatus in this embodiment is applied to the central processing unit (CPU) of a map rendering device. As shown in FIG. 6, the map rendering apparatus includes: a map data acquisition module 610, a data integration module 620, a data filling instruction generation module 630, and a rendering instruction generation module 640.

The map data acquisition module 610 is configured to obtain map data, wherein the map data includes one or more sets of model data, and the model data includes attribute data corresponding to attributes used for rendering map elements. The data integration module 620 is configured to organize the attribute data of the same attribute from the one or more sets of model data into a single data group for storage, thereby obtaining the organized attribute data and generating index data. The index data is used to indicate the storage locations of the attribute data corresponding to the attributes of the map elements. The data filling instruction generation module 630 is configured to generate data filling instructions for transmitting the organized attribute data and the corresponding index data to the graphics processor (GPU). The rendering instruction generation module 640 is configured to generate a map rendering instruction to trigger the GPU to render the map elements corresponding to the map data based on the organized attribute data and the corresponding index data.

Optionally, the attributes of the model data include vertices and colors. The attribute data corresponding to vertices is vertex data, and the attribute data corresponding to colors is color data. The data integration module 620 includes:
a color data integration unit, configured to organize the color data corresponding to colors from the one or more sets of model data into a single data group and store it in a uniform buffer object, and to generate color index data and store it in a designated first data cache region. The color index data is used to indicate the storage location of the color data for map elements in the uniform buffer object. A vertex data integration unit, configured to organize the vertex data corresponding to vertices from the one or more sets of model data into a single data group and store it in a second data cache region, and to generate vertex index data and store it in a designated third data cache region. The vertex index data is used to indicate the storage location of the vertex data corresponding to the vertices of map elements in the second data cache region.

Optionally, the color data integration unit is specifically configured to:
extracting the color data corresponding to colors from the one or more sets of model data; if there are duplicate values in the color data, organize the non-duplicate color data from the one or more sets of model data together with one instance of the duplicate values into a single data group and store it in the uniform buffer object; generate color index data and store it in the designated first data cache region.

Optionally, the data filling instructions include one first data filling instruction and at least one second data filling instruction. The data filling instruction generation module 630 is specifically configured to:
generating the first data filling instruction to transmit the vertex index data to the GPU; generate at least one second data filling instruction to transmit the organized color data, the color index data, and the organized vertex data to the GPU.

Optionally, the apparatus further includes:
a texture determination module, configured to determine whether the one or more sets of model data include texture data.

Accordingly, the data integration module 620 is specifically configured to:
if none of the one or more sets of model data include texture data, organize the attribute data of the same attribute from the model data into a single data group for storage, and generate index data.

The map rendering apparatus provided in the embodiments of the present application can be used to execute the technical solutions of the map rendering method described in the embodiments corresponding to FIG. 2 to FIG. 3. The implementation principles and technical effects are similar and will not be repeated here.

Embodiments of the present application also provide another map rendering apparatus, applied to the graphics processor (GPU) of a map rendering device. This map rendering apparatus includes:
a rendering instruction response module, configured to, in response to a map rendering instruction, read the corresponding organized attribute data and its respective index data. The corresponding organized attribute data is obtained by organizing the attribute data of the same attribute from one or more sets of model data into a single data group. The model data includes attribute data corresponding to attributes used for rendering map elements, and the index data is used to indicate the storage locations of the attribute data corresponding to the attributes of the map elements within the organized attribute data. A rendering module, configured to render one or more map elements corresponding to the map rendering instruction based on the organized attribute data and its respective index data.

Optionally, the attributes of the model data include vertices and colors. The attribute data corresponding to vertices is vertex data, and the attribute data corresponding to colors is color data. The organized attribute data includes organized vertex data and organized color data. The organized vertex data is stored in a second data cache region, and the organized color data is stored in a uniform buffer object. The index data includes color index data and vertex index data, with the color index data stored in a designated first data cache region and the vertex index data stored in a designated third data cache region.

Accordingly, the apparatus further includes:
a data filling module, configured to, before reading the corresponding organized attribute data and its respective index data in response to the map rendering instruction, respond to a first data filling instruction by obtaining the vertex index data from the third data cache region; and respond to at least one second data filling instruction by obtaining the organized color data from the uniform buffer object, the organized vertex data from the second data cache region, and the color index data from the first data cache region.

The map rendering apparatus provided in the embodiments of the present application can be used to execute the technical solutions of the map rendering method described in the embodiment corresponding to FIG. 5. The implementation principles and technical effects are similar and will not be repeated here.

FIG. 7 is a schematic structural diagram of a map rendering device provided in an embodiment of the present application. As shown in FIG. 7, the map rendering device 700 provided in this embodiment includes:
at least one processor 710; and a memory 720 communicatively connected to the at least one processor. The memory 720 stores computer-executable instructions, and the at least one processor 710 executes the computer-executable instructions stored in the memory to cause the map rendering device 700 to perform the method provided in any of the aforementioned embodiments.

Optionally, the memory 720 may be either independent or integrated with the processor 710.

The implementation principles and technical effects of the map rendering device provided in this embodiment can be referred to in the aforementioned embodiments and will not be repeated here.

Embodiments of the present application also provide a computer-readable storage medium. The computer-readable storage medium stores computer-executable instructions which, when executed by a processor, implement the method provided in any of the aforementioned embodiments.

Embodiments of the present application also provide a computer program product, which includes a computer program that, when executed by a processor, implements the method provided in any of the aforementioned embodiments.

In the embodiments provided in the present application, it should be understood that the disclosed devices and methods can be implemented in other ways. For example, the device embodiments described above are merely illustrative. The division of modules represents only one logical functional partition; in actual implementation, other partitioning approaches may be adopted. For instance, a plurality of modules may be combined or integrated into another system, or certain features may be omitted or not executed.

The integrated modules implemented in the form of software functional modules as described above can be stored in a computer-readable storage medium. These software functional modules, stored in a storage medium, include several instructions to enable a computing device (such as a personal computer, server, or network device) or processor to execute part of the steps of the methods described in various embodiments of this application.

It should be understood that the aforementioned processor may be a Central Processing Unit (CPU), or may be another general-purpose processor, a Digital Signal Processor (DSP), an Application-Specific Integrated Circuit (ASIC), or the like. The general-purpose processor may be a microprocessor or any conventional processor. The steps of the methods disclosed in the application may be performed directly by hardware processors or by a combination of hardware and software modules within the processor. The memory may include high-speed memory and may also include non-volatile memory, such as at least one disk storage device, or could be a USB flash drive, external hard drive, read-only memory (ROM), magnetic disk, optical disk, etc.

The storage medium may be implemented by any type of volatile or non-volatile storage device, or a combination thereof, such as static random-access memory, electrically erasable programmable read-only memory, erasable programmable read-only memory, programmable read-only memory, read-only memory, magnetic storage, flash memory, disks, or optical discs. The storage medium can be any available medium that is accessible by a general-purpose or dedicated computer.

An exemplary storage medium is coupled to a processor, enabling the processor to read information from the storage medium and write information to the storage medium. Of course, the storage medium may also be a component of the processor. The processor and storage medium may be located in a dedicated integrated circuit. Alternatively, the processor and storage medium can also exist as discrete components within an electronic device or map rendering device.

It should be noted that in this document, the terms “include,” “comprise,” or any other variations thereof are intended to cover non-exclusive inclusion, such that a process, method, item, or apparatus that includes a series of elements not only comprises those elements but also encompasses other elements not explicitly listed, or elements inherent to such process, method, item, or apparatus. Without further limitation, an element defined by the phrase “comprising a . . . ” does not exclude the presence of additional identical elements in the process, method, item, or apparatus that includes that element.

The embodiment numbers in this application are for descriptive purposes only and do not represent any preference regarding the superiority of the embodiments.

Through the description of the above embodiments, those skilled in the art can clearly understand that the methods of the aforementioned embodiments can be implemented by software combined with the necessary general-purpose hardware platform, or alternatively, through hardware alone. However, in many cases, the former is the preferred implementation. Based on this understanding, the technical solutions of this application, or the contributions made to the prior art, can be embodied in the form of a software product. This computer software product is stored in a storage medium (such as ROM/RAM, magnetic disks, optical discs) and includes several instructions that enable a terminal device (which may be a mobile phone, computer, server, air conditioner, network device, etc.) to execute the methods provided by the various embodiments of this application.

The above description only represents the preferred embodiments of this disclosure and an explanation of the technical principles applied. Those skilled in the art should understand that the scope of the invention involved in this disclosure is not limited to the specific combinations of technical features mentioned above. It should also cover other technical solutions formed by any combination of the above technical features or their equivalents without departing from the inventive concept. For example, the features mentioned above may be replaced with other technical features disclosed in this application (but not limited to) that have similar functions, forming a technical solution.

What is claimed is:

1. A method for map rendering, comprising:
obtaining map data, wherein the map data comprises more than one set of model data, and the model data comprises attribute data representing attributes for rendering map elements;
organizing the attribute data corresponding to a same attribute across the more than one set of model data into a data group for storage, to obtain organized attribute data, and generating index data, wherein the index data is configured to indicate the storage locations of the attribute data corresponding to the attributes of the map elements;
generating a data filling instruction to transmit the organized attribute data and the corresponding index data to a graphics processing unit (GPU); and
generating a map rendering instruction to trigger the GPU to render the map elements corresponding to the map data based on the organized attribute data and the corresponding index data.

2. The method according to claim 1, wherein the attributes of the model data comprise vertices and colors, the attribute data corresponding to the vertices comprises vertex data, and the attribute data corresponding to the colors comprises color data.

3. The method according to claim 2, wherein organizing the attribute data corresponding to a same attribute across the more than one set of model data into a data group for storage, to obtain organized attribute data, and generating index data, wherein the index data is configured to indicate the storage locations of the attribute data corresponding to the attribute of the map elements, comprises:
organizing the color data corresponding to the colors from the more than one set of model data into a data group and storing the data group into a uniform buffer object, generating color index data and storing it in a designated first data cache region, wherein the color index data is configured to indicate the storage location of the color data of map elements within the uniform buffer object; and
organizing the vertex data corresponding to the vertices from the more than one set of model data into a data group and storing the data group into a second data cache region, generating vertex index data and storing it in a designated third data cache region, wherein the vertex index data is configured to indicate the storage location of the vertex data corresponding to the vertices of the map elements within the second data cache region.

4. The method according to claim 3, wherein the data filling instruction comprises a first data filling instruction and at least one second data filling instruction, and generating a data filling instruction to transmit the organized attribute data and the corresponding index data to a GPU comprises:
generating the first data filling instruction to transmit the vertex index data to the GPU; and
generating the at least one second data filling instruction to transmit the organized color data, the color index data, and the organized vertex data to the GPU.

5. The method according to claim 3, wherein organizing the color data corresponding to the colors from the more than one set of model data into a data group and storing the data group into a uniform buffer object comprises:
extracting the color data corresponding to the colors from the more than one set of model data; and
if a duplicate value exists within the color data, organizing non-duplicate color data from the more than one set of model data and one instance of each duplicate value into a data group and storing the data group in the uniform buffer object.

6. The method according to claim 1, further comprising:
determining whether the more than one set of model data include texture data; and
if not, performing the step of organizing the attribute data corresponding to a same attribute across the more than one set of model data into a data group for storage and generating index data.

7. A non-transitory computer-readable storage medium configured with instructions executable by one or more processors to cause the one or more processors to perform the method of claim 1.

8. A method for map rendering, comprising:
in response to a map rendering instruction, reading corresponding organized attribute data and associated index data, wherein the corresponding organized attribute data is obtained by organizing attribute data corresponding to a same attribute across more than one set of model data into a data group, the model data comprising attribute data representing attributes for rendering map elements, and the index data being configured to indicate the storage locations of the attribute data corresponding to the attributes of the map elements within the organized attribute data; and
rendering more than one map elements corresponding to the map rendering instruction based on the organized attribute data and the associated index data.

9. The method according to claim 8, wherein the attributes of the model data comprise vertices and colors, the attribute data corresponding to the vertices comprises vertex data, and the attribute data corresponding to the colors comprises color data; the organized attribute data comprises organized vertex data and organized color data, the organized vertex data being stored in a second data cache region, and the organized color data being stored in a uniform buffer object; the index data comprises color index data and vertex index data, the color index data being stored in a designated first data cache region, and the vertex index data being stored in a designated third data cache region; and prior to reading the corresponding organized attribute data and associated index data in response to the map rendering instruction, the method further comprises:
in response to a first data filling instruction, obtaining the vertex index data from the third data cache region; and
in response to at least one second data filling instruction, obtaining the organized color data from the uniform buffer object, the organized vertex data from the second data cache region, and the color index data from the first data cache region.

10. A non-transitory computer-readable storage medium configured with instructions executable by one or more processors to cause the one or more processors to perform the method of claim 8.

11. An electronic device comprising:
one or more processors; and
one or more computer-readable memories coupled to the one or more processors and having instructions stored thereon that are executable by the one or more processors to perform one or more operations comprising:
obtaining map data, wherein the map data comprises more than one set of model data, and the model data comprises attribute data representing attributes for rendering map elements;
organizing the attribute data corresponding to a same attribute across the more than one set of model data into a data group for storage, to obtain organized attribute data, and generating index data, wherein the index data is configured to indicate storage locations of the attribute data corresponding to the attributes of the map elements;
generating a data filling instruction to transmit the organized attribute data and the corresponding index data to a graphics processing unit (GPU); and
generating a map rendering instruction to trigger the GPU to render the map elements corresponding to the map data based on the organized attribute data and the corresponding index data.

12. The electronic device according to claim 11, wherein the attributes of the model data comprise vertices and colors, the attribute data corresponding to the vertices comprises vertex data, and the attribute data corresponding to the colors comprises color data.

13. The electronic device according to claim 12, wherein organizing the attribute data corresponding to a same attribute across the more than one set of model data into a data group for storage, to obtain organized attribute data, and generating index data, wherein the index data is configured to indicate storage locations of the attribute data corresponding to the attribute of the map elements, comprises:
organizing the color data corresponding to the colors from the more than one set of model data into a data group and storing the data group into a uniform buffer object, generating color index data and storing it in a designated first data cache region, wherein the color index data is configured to indicate the storage location of the color data of map elements within the uniform buffer object; and
organizing the vertex data corresponding to the vertices from the more than one set of model data into a data group and storing the data group into a second data cache region, generating vertex index data and storing it in a designated third data cache region, wherein the vertex index data is configured to indicate the storage location of the vertex data corresponding to the vertices of the map elements within the second data cache region.

14. The electronic device according to claim 13, wherein the data filling instruction comprises a first data filling instruction and at least one second data filling instruction, and generating a data filling instruction to transmit the organized attribute data and the corresponding index data to a GPU comprises:
generating the first data filling instruction to transmit the vertex index data to the GPU; and
generating the at least one second data filling instruction to transmit the organized color data, the color index data, and the organized vertex data to the GPU.

15. The electronic device according to claim 13, wherein organizing the color data corresponding to the colors from the more than one set of model data into a data group and storing the data group into a uniform buffer object comprises:
extracting the color data corresponding to the colors from the more than one set of model data; and
if a duplicate value exists within the color data, organizing non-duplicate color data from the more than one set of model data and one instance of each duplicate value into a data group and storing the data group in the uniform buffer object.

16. The electronic device according to claim 11, further comprising:
determining whether the more than one set of model data include texture data; and
if not, performing the step of organizing the attribute data corresponding to a same attribute across the more than one set of model data into a data group for storage and generating index data.
